(19) United States
(12) Patent Application Publication
(10) Pub. No.: US 2025/0294244 A1
(43) Pub. Date: Sep. 18, 2025

(54) BIOLOGICAL INFORMATION RECOGNITION

(71) Applicant: TENCENT TECHNOLOGY (SHENZHEN) COMPANY LIMITED, Shenzhen (CN)

(72) Inventors: Shaoming WANG, Shenzhen (CN); Jinkun HOU, Shenzhen (CN); Runzeng GUO, Shenzhen (CN)

(73) Assignee: TENCENT TECHNOLOGY (SHENZHEN) COMPANY LIMITED, Shenzhen (CN)

(21) Appl. No.: 19/225,989

(22) Filed: Jun. 2, 2025

Related U.S. Application Data
(63) Continuation of application No. PCT/CN2024/085155, filed on Apr. 1, 2024.

(30) Foreign Application Priority Data
Apr. 27, 2023 (CN) 202310481672.8

(51) Int. Cl. H04N 23/65; G06Q 20/40; G06V 40/16

(52) U.S. Cl. CPC H04N 23/651; G06Q 20/40145; G06V 40/172

(57) ABSTRACT

Based on historical usage information of a device for biological information recognition, at least a first camera from cameras of the device is selected. The cameras are configured to respectively collect biological information images for services. At least a second camera in the cameras is configured in a power saving mode, the second camera is not selected based on the historical usage information of the device. A target biological information image of a target object is obtained by using the first camera, the target biological information image includes identifiable biological information of the target object. Image recognition processing is performed based on the target biological information image, to obtain object identity information of the target object according to the identifiable biological information in the target biological information image. The target object is provided with a target service of the services based on the object identity information.

### RELATED APPLICATIONS

The present application is a continuation of International Application No. PCT/CN2024/085155, filed on Apr. 1, 2024, which claims priority to Chinese Patent Application No. 202310481672.8, filed on Apr. 27, 2023. The entire disclosures of the prior applications are hereby incorporated by reference.

### FIELD OF THE TECHNOLOGY

This application relates to the field of computers, including biological information recognition technologies.

### BACKGROUND OF THE DISCLOSURE

In recent years, a service mode of providing a corresponding service (such as a payment service) for a user based on biological information of the user becomes increasingly common. A device for biological information recognition powered by a battery is increasingly popular.

However, in actual usage, the device for biological information recognition usually enables multiple groups of recognition devices to continuously recognize biological information for a long time. This process has relatively high power consumption, leading to a relatively short endurance of a device for biological information recognition powered by a battery, and limiting use scenarios of this type of device for biological information recognition.

### SUMMARY

Embodiments of this disclosure provide a method and an apparatus for biological information recognition, an electronic device, and a storage medium. An endurance time of a device for biological information recognition powered by a battery is prolonged, thereby helping expand use scenarios of such a device for biological information recognition.

Some aspects provide a method of biological information recognition. In some examples, based on historical usage information of a device for the biological information recognition, at least a first camera from a plurality of cameras of the device is selected. The plurality of cameras are configured to respectively collect biological information images for services. At least a second camera in the plurality of cameras is configured in a power saving mode, the second camera is not selected based on the historical usage information of the device. A target biological information image of a target object is obtained by using the first camera, the target biological information image includes identifiable biological information of the target object. Image recognition processing is performed based on the target biological information image, to obtain object identity information of the target object according to the identifiable biological information in the target biological information image. The target object is provided with a target service based on the object identity information.

Some aspects of the disclosure provide an apparatus that is configured to perform the method of biological information recognition.

An embodiment of this disclosure provides a method for biological information recognition performed by an electronic device. The method includes determining, based on historical usage information of a device for biological information recognition, a target camera corresponding to the device for biological information recognition, the target camera being a camera that is on the device for biological information recognition and that is configured to collect a biological information image based on which a target service is provided. The method includes shooting identifiable biological information of a target object by using the target camera, to obtain a target biological information image including the identifiable biological information. The method includes performing image recognition processing based on the target biological information image, to obtain object identity information corresponding to the identifiable biological information in the target biological information image. The method includes providing the target object with the target service based on the object identity information.

An embodiment of this disclosure further provides an apparatus for biological information recognition, the apparatus including: a camera determining unit, a picture obtaining unit, an identity information obtaining unit, and a service providing unit.

The camera determining unit is configured to determine, based on historical usage information of a device for biological information recognition, a target camera corresponding to the device for biological information recognition, where the target camera is a camera that is on the device for biological information recognition and that is configured to collect a biological information image based on which a target service is provided.

The picture obtaining unit is configured to shoot identifiable biological information of a target object by using the target camera, to obtain a target biological information image including the identifiable biological information.

The identity information obtaining unit is configured to perform image recognition processing based on the target biological information image, to obtain object identity information corresponding to the identifiable biological information in the target biological information image.

The service providing unit is configured to provide the target object with the target service based on the object identity information.

An embodiment of this disclosure further provides an electronic device, including a processor (an example of processing circuitry) and a memory, the memory having a plurality of instructions stored therein; where the processor is configured to load an instruction from the memory, to implement the operations in the foregoing method for biological information recognition.

An embodiment of this disclosure further provides a computer-readable storage medium (e.g., non-transitory computer-readable storage medium) having a plurality of instructions stored therein, where the instructions are used to be loaded by a processor, to implement the operations in the foregoing method for biological information recognition.

An embodiment of this disclosure further provides a computer program product, including a computer program/an instruction, the computer program/instruction, when executed by a processor, implementing the operations in the foregoing method for biological information recognition.

In the method for biological information recognition provided in this embodiment of this disclosure, the target camera of the device for biological information recognition may be determined based on the historical usage information of the device for biological information recognition. Then, the identifiable biological information reflecting uniqueness of the identity of the target object is shot by using the determined target camera, to obtain the corresponding target biological information image. Image recognition processing is performed on the target biological information image, to obtain corresponding object identity information. Next, a target service is provided for the target object based on the object identity information.

In this embodiment of this disclosure, the target camera may be determined based on the historical usage information of the device for biological information recognition, and the identifiable biological information is shot based on the determined target camera, to facilitate a subsequent image recognition processing process and a service procedure accordingly. Compared with the related technology in which multiple groups of devices for recognition are simultaneously enabled to continuously perform biological information recognition for a long time, according to the embodiments of this disclosure, long-term continuous usage of some cameras for a long time can be reduced. That is, it is determined, based on historical usage information of the device for biological information recognition, a part of cameras as a target camera, and subsequent image collection is performed by using only the target camera, thereby facilitating endurance of using a device for biological information recognition powered by a battery, and increasing use scenarios of the device for biological information recognition.

### BRIEF DESCRIPTION OF THE DRAWINGS

FIG. 1a is a schematic diagram of a use scenario of a method for biological information recognition according to an embodiment of this disclosure;

FIG. 1b is a structural block diagram of interaction between a device for biological information recognition and a server;

FIG. 1c is a time sequence diagram of interaction between a device for biological information recognition and a server;

FIG. 1d is a schematic flowchart of a method for biological information recognition according to an embodiment of this disclosure;

FIG. 2 is a schematic flowchart of a method for biological information recognition according to another embodiment of this disclosure;

FIG. 3 is a schematic structural diagram of an apparatus for biological information recognition according to an embodiment of this disclosure; and

FIG. 4 is a schematic structural diagram of an electronic device according to an embodiment of this disclosure.

### DESCRIPTION OF EMBODIMENTS

The following describes technical solutions in embodiments of this disclosure with reference to the accompanying drawings. The described embodiments are some of the embodiments of this disclosure rather than all of the embodiments. Other embodiments are within the scope of this disclosure.

Examples of terms involved in the aspects of the disclosure are briefly introduced. The descriptions of the terms are provided as examples only and are not intended to limit the scope of the disclosure.

Embodiments of this disclosure provide a method and an apparatus for biological information recognition, an electronic device, and a storage medium.

The apparatus for biological information recognition may be specifically integrated in an electronic device, and the electronic device may be a device such as a terminal or a server. The terminal may be a device such as a mobile phone, a tablet computer, a smart Bluetooth device, a notebook computer, or a personal computer (PC), or may be an intelligent device with computing capabilities. The server may be an independent server, or may be a server cluster formed by a plurality of servers, or may be a cloud server.

In some embodiments, the apparatus for biological information recognition may alternatively be integrated in a plurality of electronic devices. For example, the apparatus for biological information recognition may be integrated in a plurality of servers, and the plurality of servers implements the method for biological information recognition according to this disclosure.

In some embodiments, the server may alternatively be implemented in a form of a terminal.

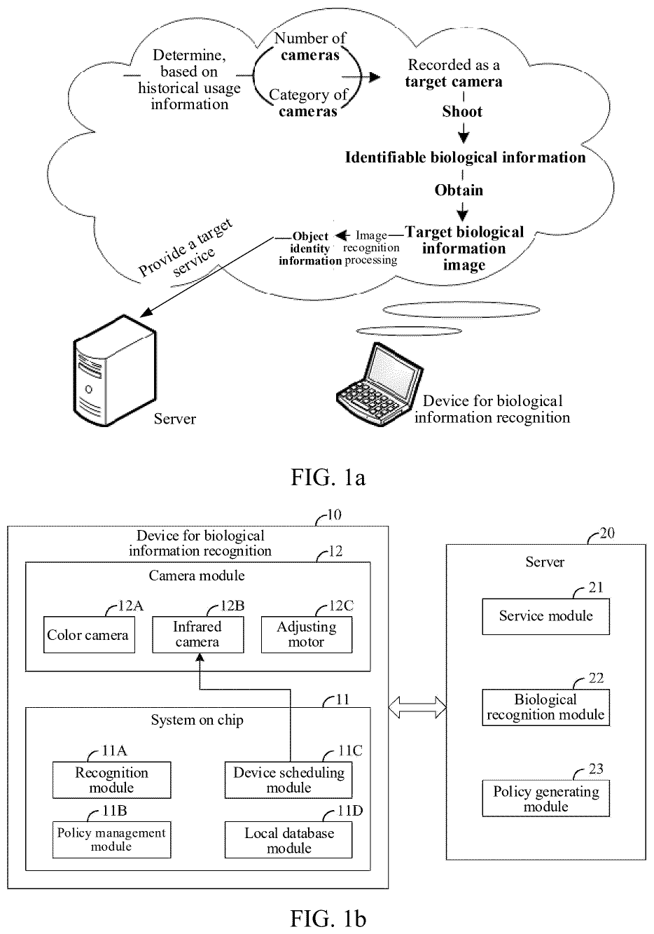

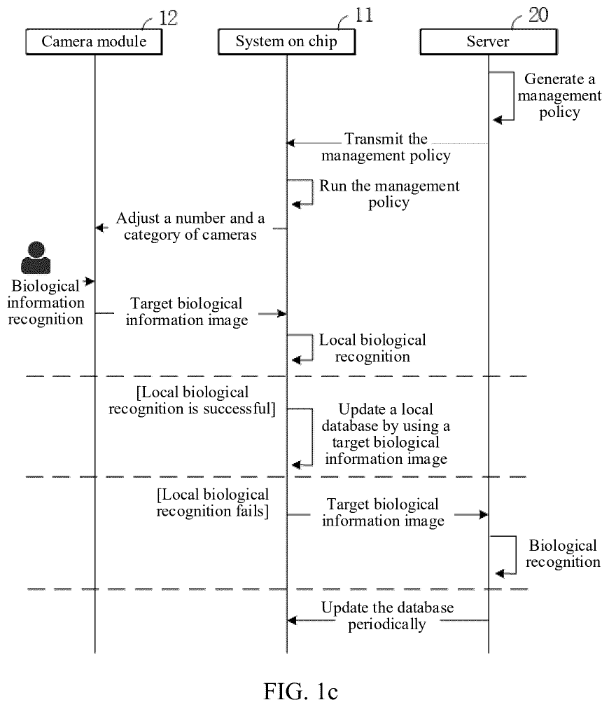

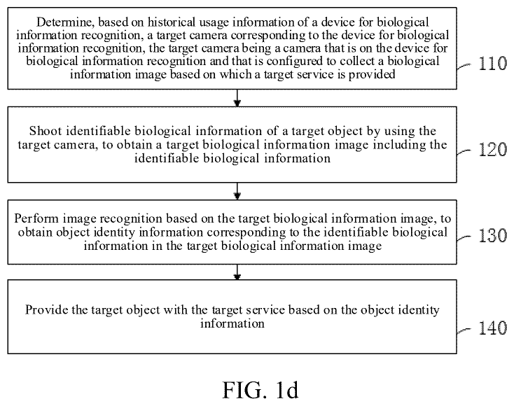

Referring to FIG. 1a, the method according to an embodiment of this disclosure includes: determining, based on historical usage information of a device for biological information recognition, a target camera corresponding to the device for biological information recognition, the target camera being a camera that is on the device for biological information recognition and that is configured to collect a biological information image based on which a target service is provided; shooting identifiable biological information of a target object by using the target camera, to obtain a target biological information image including the identifiable biological information; performing image recognition processing on the target biological information image, to obtain object identity information corresponding to the identifiable biological information in the target biological information image; and providing the target object with a target service based on the object identity information.

According to the foregoing method, the target camera is determined based on the historical usage information of the device for biological information recognition, and the identifiable biological information is shot based on the determined target camera, to facilitate a subsequent image recognition processing process and a transaction amount settlement process. According to the embodiments of this disclosure, continuous usage of some cameras for a long time can be reduced, avoiding reduction in endurance due to simultaneous usage of a plurality of cameras, and increasing use scenarios of the device for biological information recognition.

Referring to FIG. 1b, FIG. 1b is a schematic block diagram of interaction between a device for biological information recognition 10 and a server 20.

The device for biological information recognition 10 includes a system on chip (SoC) 11 integrated with an operating system (OS), and a camera module 12. The foregoing operating system may be an Android system, or may be an iOS system. A specific type of the operating system is not to be construed as a limitation to this disclosure.

The camera module 12 includes a color camera 12A, an infrared camera 12B, and an adjusting motor 12C.

The color camera 12A is configured to determine, based on R (Red), G (Green), and B (Blue) ratios of a reflected light, a color on a surface of an object at a target location with high precision, so as to obtain a color image of the target object. The color camera 12A may be specifically a color sensor.

The infrared camera 12B is configured to detect infrared energy of the target, and form an image based on temperature distribution of the target. The infrared camera 12B may be specifically an infrared sensor.

The adjusting motor 12C is configured to adjust a focal length of the color camera or the infrared camera. The adjusting motor 12C may be specifically a voice coil motor.

An application (APP) for biological information recognition runs on the system on chip 11. The APP is integrated with a recognition module 11A, a policy management module 11B, a device scheduling module 11C, and a local database module 11D.

The recognition module 11A may operate in the following two modes of operation: a mode of operation for scanning biological information and a mode of operation for scanning an electronic code (such as a two-dimensional code). The two modes of operation are used for different objects recognition and therefore correspond to different shooting focal lengths, and adjustment and switching of the shooting focal lengths need to be implemented by using the adjusting motor 12C in the camera module 12.

If the recognition module 11A operates in the mode of operation for scanning biological information, the recognition module 11A may specifically obtain a video clip that is shot by the camera and that includes the identifiable biological information. The recognition module 11A may select an optimal biological information picture from the video clip, and then perform image recognition on the biological information picture to obtain corresponding user identity information, so as to subsequently provide a corresponding service (such as a payment service) for the user based on the user identity information.

If the recognition module 11A operates in the mode of operation for scanning an electronic code, the recognition module 11A obtains the electronic code, and sends the electronic code to an identification code parsing component for parsing, so as to provide a corresponding service based on parsed information.

The policy management module 11B is configured to receive a management policy delivered by the server 20, convert the management policy into instruction information, and transmit the instruction information to the device scheduling module 11C. The management policy may be specifically: determining a target camera based on whether a quantity of transaction orders and a transaction amount and a size of a database corresponding to the device for biological information recognition in a first historical time period satisfy a corresponding preset requirement and whether a worker exists in a site in which the device for biological information recognition 10 is located. This is described in detail below.

The device scheduling module 11C is configured to schedule, based on the instruction information transmitted by the policy management module 11B, a corresponding camera component to start to work or stop working.

The local database module 11D is configured to store the data related to the biological information and the management policy delivered by the server 20. The database may be specifically an SQLite database.

The application running in the server 20 is integrated with: a service module 21, a biological recognition module 22, and a policy generating module 23.

The service module 21 is configured to communicate with a corresponding service providing device after corresponding user identity information is determined, so as to assist in providing the corresponding service for the user.

The biological recognition module 22 is configured to perform a biological recognition process in a database corresponding to the server 20 when the device for biological information recognition 10 cannot obtain a result through recognizing. A biological recognition process for the biological recognition module 22 is similar to a recognition process when the recognition module 11A operates in the mode of operation for scanning biological information, and details are not described herein again.

The policy generating module 23 is configured to generate the foregoing management policy based on the quantity of transaction orders, the transaction amount, the size of the database corresponding to the device for biological information recognition, and an environment of the site in which the device for biological information recognition 10 is located. The management policy may be transmitted to the device for biological information recognition 10.

In an implementation, the policy generating module 23 may be further configured to generate a security level of the device for biological information recognition based on the quantity of transaction orders, the transaction amount, the size of the database corresponding to the device for biological information recognition, and an environment of the site in which the device for biological information recognition 10 is located, and to transmit the security level to the device for biological information recognition 10.

In some aspects, the security level corresponding to the device for biological information recognition is determined based on whether the quantity of transaction orders and the transaction amount and the size of the database corresponding to the device for biological information recognition satisfy a corresponding preset requirement, and whether a worker exists in a site in which the device for biological information recognition is located. Specifically, the following cases may be included. For example, if the quantity of transaction orders and the transaction amount on the device for biological information recognition and the size of the database corresponding to the device for biological information recognition in the first historical time period satisfy the corresponding preset requirement, and a worker exists in the site in which the device for biological information recognition is located, it may be determined that the security level corresponding to the device for biological information recognition is a high security level. If the quantity of transaction orders and the transaction amount on the device for biological information recognition and the size of the database corresponding to the device for biological information recognition in the first historical time period satisfy the preset requirement, and no worker exists in the site in which the device for biological information recognition is located, it may be determined that the security level corresponding to the device for biological information recognition is a medium security level. If the quantity of transaction orders and the transaction amount on the device for biological information recognition and the size of the database corresponding to the device for biological information recognition in the first historical time period do not satisfy the preset requirement, it may be determined that the security level corresponding to the device for biological information recognition is a low security level.

Detailed descriptions are separately provided below. Numbering of the following embodiments is not intended to limit orders of the embodiments.

In this embodiment, a method for biological information recognition is provided. As shown in FIG. 1d, the method for biological information recognition is performed by an electronic device, and a specific procedure of the method may include the following operations 110 to 140:

110: Determine, based on historical usage information of a device for biological information recognition, a target camera corresponding to the device for biological information recognition, the target camera being a camera that is on the device for biological information recognition and that is configured to collect a biological information image based on which a target service is provided.

The historical usage information refers to usage information of the device for biological information recognition performed by a user in a historical time period, and may be specifically historical transaction information (transaction information that occurs based on the device for biological information recognition in the historical time period), or the like. The historical time period herein may be a preset time period with a fixed time length, for example, may be 24 hours, or may be another quantity of hours, for example, 12 hours. The historical time period may be specifically recorded as the first historical time period. The specific time length of the first historical time period is not to be construed as a limitation on this disclosure. The transaction information is information related to amount settlement. The transaction information may include the quantity of transaction orders and the transaction amount, and the like.

The device for biological information recognition may be provided with multiple cameras of different categories. For example, the cameras of different categories include an infrared camera, a color camera, a depth camera, or the like. Each category may include one or more cameras. In this embodiment of this disclosure, the target camera may be determined based on the historical usage information of the device for biological information recognition. The target camera is a camera used by the device for biological information recognition when the device for biological information recognition subsequently collects the biological information image, and may be at least one of multiple cameras built on the device for biological information recognition. For example, a camera of a particular category may be selected, and at least one camera is selected therefrom as the target camera.

The biological information recognized by the device for biological information recognition is biological information having a unique identity, for example, a fingerprint, a palm print, an iris, a face, or the like. The specific biological information recognized by the device for biological information recognition is not to be construed as a limitation to this disclosure.

In some aspects, in a specific implementation, in a case in which the foregoing historical usage information includes the quantity of transaction orders and the transaction amount on the device for biological information recognition and the size of the database corresponding to the device for biological information recognition in the first historical time period, operation 110 may include the following operations 111 to 114:

111. Determine whether a worker exists in a site in which the device for biological information recognition is located if the quantity of transaction orders and the transaction amount on the device for biological information recognition and the size of the database corresponding to the device for biological information recognition in the first historical time period satisfy a corresponding preset requirement.

The size of the database corresponding to the device for biological information recognition refers to: a quantity of data sets that characterize user information and that are stored locally on the device for biological information recognition. Each user has a unique corresponding data set. The data sets are in a one-to-one correspondence with the user. The data sets are used for recording information related to the user corresponding to the data sets, for example, recording identifiable biological information of the user.

Satisfying the preset requirement means that each piece of information of the historical usage information in the first historical time period corresponds to a value less than a preset value. For example, in the first historical time period, the quantity of transaction orders is less than a preset quantity of transaction orders, the transaction amount is less than a preset amount, and the size of the database corresponding to the device for biological information recognition is less than a preset size value. The preset quantity of transaction orders may be 10, or may be another number. The preset amount may be fifty thousand, or may be another amount. The preset size value may be one hundred thousand sets of data, or may be another quantity value. That is, in a specific implementation, the quantity of transaction orders and the transaction amount on the device for biological information recognition and the size of the database corresponding to the device for biological information recognition in the first historical time period satisfy the preset requirement means that: in the past 24 hours, if the quantity of transaction orders is less than ten, the transaction amount is less than fifty thousand, and the size of the database corresponding to the device for biological information recognition is less than one hundred thousand sets of data, it is determined that the preset requirement is satisfied. The specific value of the quantity of transaction orders, the preset amount, and the preset size value is not to be construed as a limitation to this disclosure.

In some aspects, in a specific implementation, the operation of “determine whether a worker exists in a site in which the device for biological information recognition is located” may specifically include the following operations 1111 to 1113:

1111: Obtain a site picture of the site in which the device for biological information recognition is located.

The site picture of the site in which the device for biological information recognition is located may be shot by using a camera installed at the site. The camera for obtaining the site picture may not be a camera disposed on the device for biological information recognition, for example, it may be a camera installed at the site, or may be a camera disposed on the device for biological information recognition. A source of the camera for obtaining the site picture is not to be construed as a limitation to this disclosure.

1112: Perform image recognition on the site picture, to obtain a site recognition result.

1113: Determine whether a worker exists in the site based on the site recognition result.

A determining result includes: a worker exists in the site or no worker exists in the site. The worker may be a person wearing designated clothing. Whether a worker exists in the site may be determined by performing image recognition processing on the site picture.

In this way, the site picture of the site in which the device for biological information recognition is located is obtained, and image recognition is performed on the site picture to determine whether a worker exists in the site. In this way, it can be determined accurately whether a worker exists in the site, thereby facilitating accurately determining, based on the determining result, the target camera that needs to be turned on by the device for biological information recognition.

In some aspects, in a specific implementation, operation 1113 may specifically include the following operations A1 to A7:
A1: Determine whether a person wearing designated clothing exists among persons existing in the site. If yes, perform operation A2; or if no, perform operation A3.
A2: Determine a worker exists at the site.
A3: For any person among the persons existing in the site, determine whether facial information of the person can be obtained. If yes, perform operation A4; or if no, perform operation A6.
A4: Compare the facial information of the person with a database of worker facial information until corresponding facial data is found in the database of worker facial information, or traversing of the database of worker facial information is completed.
A5: Determine that a worker exists in the site if corresponding facial data is found in the database of worker facial information. If the traversing of the database of worker facial information is completed, a person (different from the person selected in a previous turn) is selected (e.g., randomly) again, and operation A3 is performed, until all persons in the site are selected.

It is determined that no worker exists in the site if all persons in the site are selected.
A6: Obtain a body shape of the person, and compare the body shape of the person with a database of worker body shape information until corresponding body shape data is found in the database of worker body shape information, or traversing of the database of worker body shape information is completed.
A7: Determine that a worker exists in the site if corresponding body shape data is found in the database of worker body shape information. If the traversing of the database of worker body shape information is completed, a person (different from the person selected in a previous turn) is selected (e.g., randomly) again, and operation A3 is performed, until all persons in the site are selected.

It is determined that no worker exists in the site if all persons in the site are selected.

In the foregoing implementation, whether a person wearing designated clothing exists among persons existing in the site may be determined first. If yes, it may be directly determined that a worker exists in the site. Or if no, traversing of the persons in the site may be performed. If a front face of a person faces the camera, facial information of the person may be obtained, and the facial information is compared with the database of worker facial information (with facial data of workers input in advance stored therein) until facial information of the worker is found in the database of worker facial information, or the traversing of all persons in the site is completed. If a back face or a side face of a person faces the camera, a body shape of the person may be obtained, and the body shape is compared with the database of worker body shape information (with body shape data of workers input in advance stored therein) until a body shape of the worker is found in the database of worker body shape information, or the traversing of all persons in the site is completed.

If the facial information of the worker is found in the database of worker facial information, or the body shape of the worker is found in the database of worker body shape information, it may also be determined that a worker exists in the site. If no matched facial information is found in the database of worker facial information or no matched body shape is found in the database of worker body shape information after the traversing of all persons in the site is completed, it is determined that no worker exists in the site. According to the foregoing implementation, whether a worker exists in the site may be determined more completely and comprehensively with multi-dimensional information.

In some aspects, in an implementation, before obtaining facial information of the person in the site, voice inquiries may be made to inquire whether the person in the site agrees to proceed. The facial information may be obtained after obtaining a positive response from the person in the site. If the person in the site responses with a negative reply, it may be determined that there is no worker in the site.

In the foregoing implementation, whether a worker exists in the site may be used as a reference factor for selecting a type of target camera. An appropriate target camera is selected based on whether a worker exists in the site, achieving a balance between power consumption saving and recognition accuracy ensuring, and improving endurance of the device for biological information recognition.

112: Determine a color camera as the target camera if the worker exists in the site in which the device for biological information recognition is located.

The color camera is configured to determine, based on R, G, and B ratios of a reflected light, a color on a surface of an object at a target with high precision, so as to obtain a color image of the target object.

In some aspects, if a worker exists in the site, it is usually difficult to scan biological information of a target object that is to use a related service through the device for biological information recognition in a non-living manner. A non-living object is, for example, a picture or a video including biological information. Therefore, when a worker exists in the site, the infrared camera used for detecting a living object may be selectively turned off (an example of in a power save mode), and only the color camera is turned on, so that energy consumption of the device for biological information recognition is reduced, improving endurance of the device for biological information recognition.

113: Determine an infrared camera as the target camera if no worker exists in the site in which the device for biological information recognition is located.

The infrared camera is configured to detect infrared energy of the target, and form an image based on temperature distribution of the target.

In some aspects, if no worker exists in the site, it is possible to scan biological information of a target object that is to use a related service through the device for biological information recognition in the non-living manner. Therefore, when no worker exists in the site, the infrared camera may be turned on to perform liveness detection based on the image collected by the infrared camera, to avoid an attack from a non-living object. Meanwhile, the color camera is turned off, so that energy consumption of the device for biological information recognition is reduced, improving endurance of the device for biological information recognition.

In this way, in a case in which the historical usage information of the device for biological information recognition satisfies the preset requirement, whether a worker exists in the site in which the device for biological information recognition is located is further detected. A decision is made to enable the color camera or the infrared camera on the device for biological information recognition based on a detection result. Therefore, the attack from the non-living object is avoided, energy consumption of the device for biological information recognition is reduced, and endurance is prolonged while accurate detection of the biological information is ensured.

114: Determine the color camera and the infrared camera as the target camera if the quantity of transaction orders and the transaction amount on the device for biological information recognition and the size of the database corresponding to the device for biological information recognition in the first historical time period do not satisfy the corresponding preset requirement.

Failing to satisfy the preset requirement means that any piece of the usage information in the first historical time period is higher than a corresponding preset value. For example, in the first historical time period, the quantity of transaction orders is greater than a preset quantity of transaction orders, the transaction amount is greater than a preset amount, or the size of the database corresponding to the device for biological information recognition is greater than a preset size value.

In the foregoing implementation, if the quantity of transaction orders is greater than the preset quantity of transaction orders, or if the transaction amount is greater than the preset amount, it means that a quantity of orders or a transaction amount related to the device for biological information recognition is relatively large, and therefore a higher security level is needed. Therefore, the color camera and the infrared camera may be enabled at the same time to improve the security level of the related service provided by the device for biological information recognition.

As the size of the database increases, similarities between data sets gradually become higher. When the size of the database corresponding to the device for biological information recognition is higher than the preset size value, similarity between data sets may be higher than a preset value. However, in the foregoing case, recognition accuracy of a single camera is relatively low. Therefore, it is possible to increase the recognition accuracy by simultaneously using the color camera and the infrared camera, so as to better distinguish between different users based on the collected biological information.

In this way, in a case in which the historical usage information of the device for biological information recognition does not satisfy the preset requirement, the color camera and the infrared camera can be turned on directly, to accurately recognize a corresponding user by using image information collected by both cameras, thereby improving accuracy and reliability of biological information recognition.

In some aspects, in another implementation, the foregoing historical usage information may further include: the security level of the device for biological information recognition generated by the server based on the quantity of transaction orders, the transaction amount, the size of the database corresponding to the device for biological information recognition, and an environment of the site in which the device for biological information recognition is located. Different security levels may correspond to different numbers and categories of cameras.

For example, if the quantity of transaction orders and the transaction amount on the device for biological information recognition and the size of the database corresponding to the device for biological information recognition in the first historical time period satisfy the corresponding preset requirement, and a worker exists in the site in which the device for biological information recognition is located, it may be determined that the security level corresponding to the device for biological information recognition is a high security level. The high security level may correspond to that the color camera is turned on.

If the quantity of transaction orders and the transaction amount on the device for biological information recognition and the size of the database corresponding to the device for biological information recognition in the first historical time period satisfy corresponding preset requirement, and no worker exists in the site in which the device for biological information recognition is located, it may be determined that the security level corresponding to the device for biological information recognition is a medium security level. The medium security level may correspond to that the infrared camera is turned on.

If the quantity of transaction orders and the transaction amount on the device for biological information recognition and the size of the database corresponding to the device for biological information recognition in the first historical time period do not satisfy corresponding preset requirement, it may be determined that the security level corresponding to the device for biological information recognition is a low security level. The low security level corresponds to that the color camera and the infrared camera are turned on at the same time.

In the foregoing implementation, the quantity and category of enabled cameras are determined based on the security level. Because the security level is evaluated by the server, a computational load of the device for biological information recognition is reduced, thereby further improving the endurance of the device for biological information recognition.

In some aspects, in a specific implementation, before operation 111, this embodiment of this disclosure may further include the following operations S1 to S6:
S1: Determine whether the device for biological information recognition has performed an operation of scanning an electronic code in a second historical time period. If no, perform operation S2; or if yes, perform operation S4.

A specific time length of the second historical time period may be the same as the time length of the first historical time period, or may be different from the time length of the first historical time period. The specific time length of the second historical time period is not to be construed as a limitation on this disclosure.

The device for biological information recognition may switch between a mode of operation for scanning biological information and a mode of operation for scanning an electronic code. The electronic code herein may be used for triggering the device for biological information recognition to provide a corresponding service. The electronic code may be, for example, a payment code or a membership identity code, and may be specifically represented as a two-dimensional code or a bar code. Therefore, whether the device for biological information recognition has performed the operation of scanning the electronic code in the second historical time period may be determined first. If no, it indicates that the device for biological information recognition operates only in the mode of operation for scanning the biological information in a relatively long historical time period, and then operation S2 may be performed. If yes, it indicates that not only the target object on which biological information recognition authentication is performed but also the target object on which electronic code authentication is performed are there in the site in which the device for biological information recognition is located, and then operation S4 may be performed.
S2: Adjust a focal length to a focal length corresponding to scanning the biological information.
S3: Set, in a preset future time period, the device for biological information recognition into a mode in which only biological information recognition is supported.

The focal length corresponding to the mode of operation for scanning the biological information is different from the focal length corresponding the mode of operation for scanning the electronic code. If the device for biological information recognition has not performed the operation of scanning the electronic code in the second historical time period, the focal length of the device for biological information recognition may be fixed to the focal length corresponding to scanning the biological information in the preset future time period, so that the device for biological information recognition supports recognition of only the biological information in the preset future time period.

In the foregoing implementation, for the device for biological information recognition that operates in the mode of operation for scanning the biological information for a long time, frequent switching of the focal length of the device for biological information recognition can be avoided by restricting the mode of operation, thereby further improving the endurance of the device for biological information recognition.
S4: Adjust the focal length to a focal length corresponding to scanning the electronic code.
S5: Determine, in the preset future time period, a type of a to-be-recognized object before the to-be-recognized object is recognized by using the device for biological information recognition.

The type includes the biological information and the electronic code. The electronic code may be a two-dimensional code, a bar code, or the like. A specific type of the electronic code is not to be construed as a limitation to this disclosure.
S6: Determine, based on the type of the to-be-recognized object, whether to switch a recognition mode of the device for biological information recognition.

If the device for biological information recognition has performed the operation of scanning the electronic code in the second historical time period, it indicates that not only the target object on which biological information recognition authentication is performed but also the target object on which electronic code authentication is performed are there in the site in which the device for biological information recognition is located. In the foregoing case, the focal length may be adjusted to the focal length corresponding to scanning the electronic code, and the type of the to-be-recognized object is determined before an identification operation is performed each time. Therefore, the mode of operation of the device for biological information recognition is switched to the mode of operation corresponding to the type of the to-be-recognized object.

In the foregoing implementation, for a use scenario that requires both recognition of the electronic code and recognition of the biological information, the device for biological information recognition may switch the mode of operation based on the type of the to-be-recognized object, thereby meeting a usage requirement of the use scenario and expanding a usage range of the device for biological information recognition.

120: Shoot identifiable biological information of a target object by using the target camera, to obtain a target biological information image including the identifiable biological information.

The identifiable biological information is biological information reflecting uniqueness of the identity of the target object. For example, the identifiable biological information may be a fingerprint, a palm print, an iris, a face, or the like. A specific biological information category of the identifiable biological information is not to be construed as a limitation to this disclosure.

For ease of description, an example in which the identifiable biological information is a palm print is used below for description.

In some aspects, in a specific implementation, operation 120 may specifically include the following operations 121 to 122:

121: Shoot a video clip including the identifiable biological information by using the target camera.

122: Select, based on a shooting angle and a picture parameter of the identifiable biological information, a picture screenshot including the identifiable biological information from the video clip as the target biological information image.

The shooting angle is an angle formed by a plane in which the identifiable biological information is located and a shooting direction of the camera. Usually, when the angle is 90 degrees, the identifiable biological information is presented clearer and more complete.

The picture parameter is a parameter reflecting a picture quality. For example, the picture parameter may be: an image contrast, an image brightness, an image definition, and the like. The image contrast refers to measurement of different brightness levels between the brightest white and the darkest black in bright and dark areas of an image, that is, a magnitude of grayscale contrast of an image. A larger difference range indicates a larger contrast, and a smaller difference range indicates a smaller contrast. The image brightness refers to the brightness level of the picture. The image definition refers to the degree of clarity of the various details and boundaries of the picture.

In some aspects, a picture screenshot of which the shooting angle, the image contrast, the image brightness, and the image definition all satisfy corresponding requirements may be selected from the video clip of the shot identifiable biological information, and the picture screenshot is recorded as the target biological information image.

In the foregoing implementation, as a biological information picture is selected from a video clip including multiple frames of images, an image quality of the target biological information image can be improved as much as possible, thereby establishing a good foundation for the subsequent recognition process and further increasing the accuracy of recognition.

130. Perform image recognition processing based on the target biological information image, to obtain object identity information corresponding to the identifiable biological information in the target biological information image.

The image recognition refers to a technology of processing, analyzing, and understanding an image by using a computer, to recognize targets and objects in different modes. A process of image recognition may be implemented by using a deep learning algorithm, or may be implemented by using another technology, such as ChatGPT.

In some aspects, in a specific implementation, operation 130 may specifically include the following operations 131 to 136:

131: Match the target biological information image with biological information in a database corresponding to the device for biological information recognition.

The database corresponding to the device for biological information recognition is a database locally deployed in the device for biological information recognition.

In some aspects, in an implementation, the biological information in the database includes a personal biological information image of the user. Correspondingly, the foregoing matching process may be comparing the target biological information image with the personal biological information image in a database local to the device for biological information recognition, so as to obtain a matched personal biological information image.

In some aspects, in another implementation, the database includes a personal biological information feature map of the user. The personal biological information feature map may be obtained by performing feature extraction on the personal biological information image.

Correspondingly, the foregoing matching process may be: extracting a feature map of the target biological information image, and comparing the feature map of the target biological information image with the personal biological information feature map in the database local to the device for biological information recognition, so as to obtain a matched personal biological information feature map. The foregoing comparing process may specifically include: performing similarity scoring on a plurality of personal biological information feature maps separately, to obtain a personal biological information feature map with a highest score. Then, the personal biological information feature map with the highest score is compared with the feature map of the target biological information image.

The process of matching the target biological information image with the biological information in the database corresponding to the device for biological information recognition is not to be construed as a limitation to this disclosure.

132: Obtain, if the matching is successful, the object identity information corresponding to the identifiable biological information from the database corresponding to the device for biological information recognition.

The biological information and the corresponding object identity information are stored in the database as a data set. Therefore, if the matching is successful, it means that the object identity information of the object corresponding to the identifiable biological information in the target biological information image is stored in the database local to the device for biological information recognition. Therefore, the object identity information may be obtained from the foregoing database.

133: Transmit the target biological information image to a server if the matching with the biological information in the database corresponding to the device for biological information recognition is not successful, so that the server matches the target biological information image with biological information in a database of the server.

134: Receive, if the matching with the biological information in the database of the server is successful, object identity information that is transmitted by the server and that corresponds to the identifiable biological information in the target biological information image.

135: Receive, if the matching with the biological information in the database of the server fails, prompt information that is transmitted by the server and that represents a recognition failure.

If the target biological information image fails to match with the biological information in the database local to the device for biological information recognition, the device for biological information recognition will transmit the target biological information image to the server, so that the server matches the target biological information image with the biological information in the database of the server.

If the matching with the biological information in the database of the server is successful, it means that the biological information of the object and the corresponding object identity information are stored in the database of the server and are not transmitted to the device for biological information recognition. Therefore, the object identity information transmitted by the server can be received.

If the matching with the biological information in the database of the server fails, it means that the biological information of the object and the corresponding object identity information have not been recorded. Therefore, the server may transmit, to the device for biological information recognition, prompt information that represents the recognition failure, and enable the device for biological information recognition to present the prompt information.

In the foregoing implementation, the device for biological information recognition may first perform locally the matching between the target biological information image with the biological information. Performing the matching locally can improve the efficiency of biological information recognition, reduce unnecessary remote communication, and avoid wasting a communication resource. In case that the matching fails, the server then performs matching between the biological information picture and the biological information, so as to perform matching based on richer biological information. In the foregoing implementation, the foregoing two levels of matching may be used to take both quickness and comprehensiveness of matching into consideration.

136: Receive, at an interval of a preset time period, biological information transmitted by the server, to update the database corresponding to the device for biological information recognition.

The preset time period is a preset time length, and the time length may be 24 hours. That is, newly registered biological information in the server along with corresponding object identity information may be transmitted to the device for biological information recognition every 24 hours, so as to keep information of the device for biological information recognition updated. The time length may alternatively be another time length, for example, 8 hours. A specific time length of the preset time period is not to be construed as a limitation to this disclosure.

In the foregoing implementation, the biological information stored in the device for biological information recognition and the corresponding object identity information are periodically updated, so that the database of the device for biological information recognition can be expanded, and more biological information images can be successfully matched locally with the device for biological information recognition, facilitating further improving matching efficiency.

In some aspects, in a specific implementation, after the corresponding object identity information is obtained based on the target biological information image, the target biological information image may further be used to replace the personal biological information image in the database corresponding to the object identity information. For details, refer to FIG. 1c.

For example, if the target biological information image includes an infrared biological information image and a color biological information image, but the original personal biological information image in the database corresponding to the object identity information includes only a color image, the color image may be replaced with the color biological information image, and the infrared biological information image is added to the object identity information, so as to update the personal biological information image corresponding to the object identity information.

140. Provide the target object with the target service based on the object identity information.

After the object identity information is recognized and determined, a target service currently required by the target object may be correspondingly provided to the target object, such as a payment service, a check-in service, a member recognition service, a resource rental service, and the like.

An example in which the payment service is provided for the target object may be used. A payment code corresponding to the object identity information may be generated and transmitted to an amount settlement device, to perform an amount settlement process corresponding to the target object. The amount settlement device is a device for monetary settlement of a product or service purchased by a target object. For example, the amount settlement device may be a point of sales terminal (POS machine), a bar code scanner, or the like.

In this embodiment of this disclosure, the number and type of the target camera is selected with reference to the size of the database of the device for biological information recognition, the quantity of transaction orders in the first historical time period, the transaction amount in the first historical time period, and whether a worker exists in the site in which the device for biological information recognition is located. The foregoing refined selection of the target camera ensures an effect for biological information recognition, and reduces power consumption of a camera device. In this way, power consumption of the device for biological information recognition is reduced, and the endurance of the device for biological information recognition is prolonged, facilitating deployment of the device for biological information recognition in more service scenarios.

In the method for biological information recognition provided in this embodiment of this disclosure, the target camera used by the device for biological information recognition to collect the biological information image based on which the target service is provided, may be determined based on historical usage information of the device for biological information recognition. Then, the identifiable biological information reflecting uniqueness of the identity of the target object is shot by using the determined target camera, to obtain the corresponding target biological information image. Image recognition processing is performed on the target biological information image, to obtain corresponding object identity information. Next, a target service is provided for the target object based on the object identity information. In this embodiment of this disclosure, the target camera may be determined based on the historical usage information of the device for biological information recognition, and the identifiable biological information is shot based on the target camera, to facilitate a subsequent image recognition processing process and a service procedure. Compared with the related technology in which multiple groups of devices for recognition are simultaneously enabled to continuously perform biological information recognition for a long time, according to the embodiments of this disclosure, continuous usage of some cameras for a long time can be reduced. That is, it is determined, based on historical usage information of the device for biological information recognition, some cameras as target cameras, and subsequent image collection is performed by using only the target cameras, thereby facilitating endurance of using a device for biological information recognition powered by a battery.

According to this embodiment of this disclosure, use scenarios of the device for biological information recognition may be increased.

The method described in the foregoing embodiments will be described in further detail below.

In this embodiment, the method in this embodiment of this disclosure is described in detail by using an example in which the identifiable biological information is a palm print and a payment service is provided by using the device for biological information recognition.

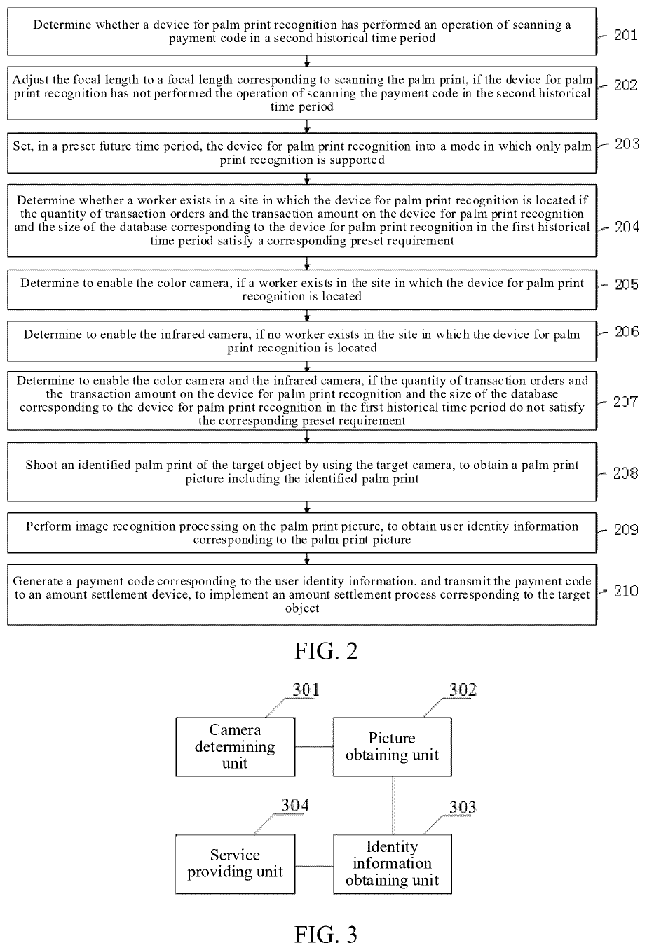

As shown in FIG. 2, a specific procedure of the method for biological information recognition is as follows:

201: Determine whether a device for palm print recognition has performed an operation of scanning a payment code in a second historical time period.

In some aspects, in an implementation, if the device for palm print recognition has performed the operation of scanning the payment code in the second historical time period, the focal length would be adjusted to a focal length corresponding to scanning the payment code. The type of the to-be-recognized object is determined before each time a recognition is performed in a preset future time period. Whether to switch a mode identified by the device for palm print recognition is determined based on the type of the to-be-recognized object.

202: Adjust the focal length to a focal length corresponding to scanning the palm print, if the device for palm print recognition has not performed the operation of scanning the payment code in the second historical time period.

203: Set, in a preset future time period, the device for palm print recognition into a mode in which only palm print recognition is supported.

204. Determine whether a worker exists in a site in which the device for palm print recognition is located if the quantity of transaction orders and the transaction amount on the device for palm print recognition and the size of the database corresponding to the device for palm print recognition in the first historical time period satisfy a corresponding preset requirement.

205: Determine to enable the color camera, if a worker exists in the site in which the device for palm print recognition is located.

206: Determine to enable the infrared camera, if no worker exists in the site in which the device for palm print recognition is located.

In some aspects, in an implementation, the determining whether a worker exists in the site in which the device for palm print recognition is located includes: obtaining a site picture of the site in which the device for palm print recognition is located; performing image recognition on the site picture, to obtain a site recognition result; and determining whether a worker exists in the site based on the site recognition result.

207: Determine to enable the color camera and the infrared camera, if the quantity of transaction orders and the transaction amount on the device for palm print recognition and the size of the database corresponding to the device for palm print recognition in the first historical time period do not satisfy the corresponding preset requirement.

In the foregoing operations, the enabled camera is determined as the target camera.

208: Shoot an identifiable palm print of the target object by using the target camera, to obtain a palm print picture including the identifiable palm print.

In some aspects, in a specific implementation, operation 208 includes: shooting a video clip including the identifiable palm print by using the target camera; and selecting, based on a shooting angle and a picture parameter of the identifiable palm print, a picture screenshot including the identifiable palm print from the video clip as the foregoing palm print picture.

209: Perform image recognition processing on the palm print picture, to obtain user identity information corresponding to the palm print picture.

In some aspects, in a specific implementation, operation 209 includes: matching the palm print picture with a palm print in a database corresponding to the device for palm print recognition; obtaining, if the matching is successful, the user identity information corresponding to the palm print picture from the database corresponding to the device for palm print recognition; transmitting, if the matching fails, the palm print picture to the server, so that the server performs matching between the palm print picture with a palm print in a database of the server; receiving, if the matching with the palm print in the database of the server is successful, the user identity information that is transmitted by the server and that corresponds to the palm print picture; and receiving, if the matching with the palm print in the database of the server fails, prompt information that is transmitted by the server and that represents a recognition failure.

In some aspects, in a specific implementation, the palm print transmitted by the server is received at an interval of a preset time period, to update the database corresponding to the device for palm print recognition.

210: Generate a payment code corresponding to the user identity information, and transmit the payment code to an amount settlement device, to implement an amount settlement process corresponding to the target object.

A specific performing process of operations 201 to 210 is described in detail above, and details are not described herein again.

In the method for biological information recognition provided in this embodiment of this disclosure, the target camera used by the device for palm print recognition to collect the biological information image based on which the payment service is provided, may be determined based on historical transaction information of the device for palm print recognition. Then, a palm print reflecting uniqueness of a consumer user identity is shot by using the determined target camera, to obtain a corresponding palm print picture. The image recognition processing is performed on the palm print picture, to obtain corresponding user identity information. A payment code corresponding to the user identity information is generated and transmitted to an amount settlement device, to implement an amount settlement process for the consumer user. In this embodiment of this disclosure, the target camera may be determined based on the historical transaction information of the device for palm print recognition, and the palm print is shot based on the target camera, to facilitate a subsequent image recognition processing process and the amount settlement process. Compared with the related technology in which multiple groups of devices for recognition are simultaneously enabled to continuously perform biological information recognition for a long time, according to the embodiments of this disclosure, usage of some cameras can be reduced. That is, it is determined, based on historical transaction information of the device for palm print recognition, some cameras as target cameras, and subsequent palm print collection is performed by using only the target cameras, thereby facilitating endurance of using a device for palm print recognition powered by a battery.

According to this embodiment of this disclosure, use scenarios of a device for biological information recognition can be added.

To better implement the foregoing method, an embodiment of this disclosure further provides an apparatus for biological information recognition. The apparatus for biological information recognition may be specifically integrated in an electronic device, and the electronic device may be a device such as a terminal or a server. The terminal may be a device such as a mobile phone, a tablet computer, a smart Bluetooth device, a notebook computer, or a personal computer (PC). The server may be a single server, or may be a server cluster formed by a plurality of servers. For example, in this embodiment, the method in this embodiment of this disclosure is described in detail by using an example in which an apparatus for biological information recognition is specifically integrated in the terminal of the electronic device.

For example, as shown in FIG. 3, the apparatus for biological information recognition may include:

a camera determining unit 301, configured to determine, based on historical usage information of a device for biological information recognition, a target camera corresponding to the device for biological information recognition, where the target camera is a camera that is on the device for biological information recognition and that is configured to collect a biological information image based on which a target service is provided;

a picture obtaining unit 302, configured to shoot identifiable biological information of a target object by using the target camera, to obtain a target biological information image including the identifiable biological information;

an identity information obtaining unit 303, configured to perform image recognition processing based on the target biological information image, to obtain object identity information corresponding to the identifiable biological information in the target biological information image; and

a service providing unit 304, configured to provide the target object with the target service based on the object identity information.

In an implementation, the historical usage information includes a quantity of transaction orders and a transaction amount on the device for biological information recognition and a size of a database corresponding to the device for biological information recognition in a first historical time period. Correspondingly, the camera determining unit 301 includes:

a personnel determining unit, configured to determine whether a worker exists in a site in which the device for biological information recognition is located when the quantity of transaction orders and the transaction amount on the device for biological information recognition and the size of the database corresponding to the device for biological information recognition in the first historical time period satisfy a corresponding preset requirement; and

a color camera enabling unit, configured to determine a color camera as the target camera when the worker exists in the site in which the device for biological information recognition is located.

In an implementation, the apparatus further includes:

an infrared camera enabling unit, configured to determine an infrared camera as the target camera when no worker exists in the site in which the device for biological information recognition is located.

In an implementation, the apparatus further includes:

a payment code scanning and determining unit, configured to determine whether the device for biological information recognition has performed an operation of scanning an electronic code in a second historical time period;

a first focal length adjusting unit, configured to adjust a focal length to a focal length corresponding to scanning the biological information when the device for biological information recognition has not performed the operation of scanning the electronic code in the second historical time period; and

a mode setting unit, configured to set, in a preset future time period, the device for biological information recognition into a mode in which only biological information recognition is supported.

In an implementation, the apparatus further includes:

a second focal length adjusting unit, configured to adjust the focal length to a focal length corresponding to scanning the electronic code when the device for biological information recognition has performed the operation of scanning the electronic code in the second historical time period;

a type determining unit, configured to determine a type of a to-be-recognized object before the to-be-recognized object is recognized by using the device for biological information recognition; and

a mode switching unit, configured to determine, based on the type of the to-be-recognized object, whether to switch a recognition mode of the device for biological information recognition.

In an implementation, the personnel determining unit includes:

a picture obtaining subunit, configured to obtain a site picture of the site in which the device for biological information recognition is located;

a recognition result subunit, configured to perform image recognition on the site picture, to obtain a site recognition result; and

a determining result subunit, configured to determine whether a worker exists in the site based on the site recognition result.

In an implementation, the historical usage information includes a quantity of transaction orders and a transaction amount on the device for biological information recognition and a size of a database corresponding to the device for biological information recognition in a first historical time period. Correspondingly, the camera determining unit 301 is further configured to:

determine the color camera and the infrared camera as the target camera when the quantity of transaction orders and the transaction amount on the device for biological information recognition and the size of the database corresponding to the device for biological information recognition in the first historical time period do not satisfy the corresponding preset requirement.

In an implementation, the picture obtaining unit 302 includes:

a video shooting subunit, configured to shoot a video clip including the identifiable biological information by using the target camera; and

a screenshot selecting subunit, configured to select, based on a shooting angle and a picture parameter of the identifiable biological information, a picture screenshot including the identifiable biological information from the video clip as the target biological information image.

In an implementation, the identity information obtaining unit 303 includes:

an information matching subunit, configured to match the target biological information image with biological information in a database corresponding to the device for biological information recognition; and

an information obtaining subunit, configured to obtain, when the matching with the biological information in the database corresponding to the device for biological information recognition is successful, the object identity information corresponding to the identifiable biological information from the database corresponding to the device for biological information recognition.

In an implementation, the apparatus further includes:

a picture transmitting unit, configured to transmit the target biological information image to a server when the matching with the biological information in the database corresponding to the device for biological information recognition is not successful, so that the server matches the target biological information image with biological information in a database of the server;

an information receiving unit, configured to receive, when the matching with the biological information in the database of the server is successful, object identity information that is transmitted by the server and that corresponds to the identifiable biological information; and

a prompt receiving unit, configured to receive, when the matching with the biological information in the database of the server fails, prompt information that is transmitted by the server and that represents a recognition failure.

In an implementation, the apparatus further includes:

an information updating unit, configured to receive, at an interval of a preset time period, biological information sent by the server, to update the database corresponding to the device for biological information recognition.

During implementation, the foregoing individual units may be implemented as independent entities, or may be implemented as a same entity or several entities combined arbitrarily. For implementation of the foregoing individual units, refer to the foregoing method embodiments. Details are not described herein again.

According to this embodiment of this disclosure, use scenarios of a device for biological information recognition can be added.

An embodiment of this disclosure further provides an electronic device. The electronic device may be a device such as a terminal or a server. The terminal may be a mobile phone, a tablet computer, a smart Bluetooth device, a notebook computer, a personal computer, and the like. The server may be a single server, or may be a server cluster formed by a plurality of servers, and the like.

In some embodiments, the apparatus for biological information recognition may alternatively be integrated in a plurality of electronic devices. For example, the apparatus for biological information recognition may be integrated in a plurality of servers, and the plurality of servers implements the method for biological information recognition according to this disclosure.

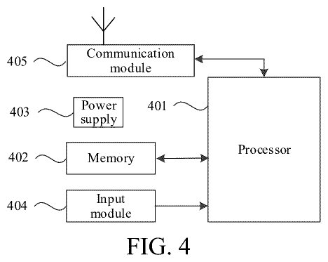

In this embodiment, the electronic device in this embodiment is described in detail by using an example in which the electronic device is an electronic device. For example, as shown in FIG. 4, FIG. 4 is a schematic structural diagram of an electronic device according to an embodiment of this disclosure. Specifically:

the electronic device may include components such as a processor 401 including one or more processing cores, a memory 402 including one or more computer-readable storage media, a power supply 403, an input module 404, and a communication module 405. It is noted that the structure of the electronic device shown in FIG. 4 does not constitute a limitation to the electronic device, and the electronic device may include more components or fewer components than those shown in the figure, or some components may be combined, or a different component deployment may be used.

The processor 401 is a control center of the electronic device, and is connected to various parts of the entire electronic device by using various interfaces and lines. By running or executing a software program and/or module stored in the memory 402, and invoking data stored in the memory 402, the processor 401 performs various functions and data processing of the electronic device. In some embodiments, the processor 401 may include one or more processing cores. In some embodiments, the processor 401 may integrate an application processor and a modem. The application processor mainly processes an operating system, a user interface, an application, and the like. The modem mainly processes wireless communication. The foregoing modem may not be integrated into the processor 401.

The memory 402 may be configured to store the software program and module. The processor 401 runs the software program and module stored in the memory 402, to implement various functional applications and data processing. The memory 402 may mainly include a program storage area and a data storage area. The program storage area may store an operating system, an application required by at least one function (such as a sound playback function and an image display function), and the like. The data storage area may store data created based on usage of the electronic device, and the like. In addition, the memory 402 may include a high speed random access memory, and may also include a non-volatile memory such as at least one magnetic disk storage device, a flash memory, or another volatile solid-state storage device. Correspondingly, the memory 402 may further include a memory controller, so as to provide access of the processor 401 to the memory 402.

The electronic device further includes the power supply 403 for supplying power to the components. In some embodiments, the power supply 403 may be logically connected to the processor 401 by using a power management system, thereby implementing functions such as charging, discharging, and power consumption management by using the power management system. The power supply 403 may further include one or more of a direct current or alternating current power supply, a re-charging system, a power failure detection circuit, a power converter or inverter, a power state indicator, and any other components.

The electronic device may further include an input module 404. The input module 404 may be configured to receive input digit or character information, and generate a keyboard, mouse, joystick, optical, or track ball signal input related to the user setting and function control.

The electronic device may further include a communication module 405. In some embodiments, the communication module 405 may include a wireless module. The electronic device may perform short-distance wireless transmission by using the wireless module of the communication module 405, so as to provide wireless broadband Internet access for a user. For example, the communication module 405 may be configured to help the user receive and send e-mails, browse a web page, access streaming media, and so on.

Although not shown in the figure, the electronic device may further include a display unit and the like, which are not further described herein. Specifically, in this embodiment, the processor 401 in the electronic device may load, according to the following instructions, executable files corresponding to processes of one or more applications into the memory 402. The processor 401 runs the applications stored in the memory 402, to implement the method for biological information recognition provided in the embodiments of this disclosure.

For specific implementation of the foregoing operations, refer to the foregoing embodiments, and details are not described herein again.

It is noted that all or some of the operations of the foregoing method embodiments may be implemented by instructions, or may be implemented by hardware related to instructions. The instructions may be stored in a computer-readable storage medium, and may be loaded and executed by the processor.

Therefore, an embodiment of this disclosure provides a computer-readable storage medium, with multiple instructions stored therein, the instructions are used to be loaded by a processor, to perform the operations in any method for biological information recognition provided in the embodiments of this disclosure.

The storage medium may include: a read only memory (ROM), a random access memory (RAM), a magnetic disk, an optical disc, or the like.

According to an aspect of this disclosure, a computer program product or a computer program is provided. The computer program product or the computer program includes a computer instruction, and the computer instruction is stored in a computer-readable storage medium. The processor of the computer device reads the computer instruction from the computer-readable storage medium, and the processor executes the computer instruction, so that the computer device performs the methods according to the various implementations provided in the foregoing embodiments.

The instruction stored in the storage medium can be used to perform the operations in any method for biological information recognition provided in the embodiments of this disclosure, beneficial effects that can be implemented by any method for biological information recognition provided in the embodiments of this disclosure can be implemented. For details, refer to the foregoing embodiments, and details are not described herein again.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The method and the apparatus for biological information recognition, the electronic device, and the computer-readable storage medium provided in the embodiments of this disclosure are described above in detail. Although the principles and implementations of this disclosure are described by using specific examples in this specification, the descriptions of the foregoing embodiments are merely intended to help understand the method and core ideas of this disclosure. It is noted that modifications can be made to the specific implementations according to the ideas of this disclosure. In conclusion, the content of this specification is not to be construed as a limitation to this disclosure.

What is claimed is:

1. A method of biological information recognition, comprising:
selecting, based on historical usage information of a device for the biological information recognition, at least a first camera from a plurality of cameras of the device, the plurality of cameras being configured to respectively collect biological information images for a plurality of services;
configuring at least a second camera in the plurality of cameras in a power saving mode, the second camera not being selected based on the historical usage information of the device;
obtaining a target biological information image of a target object by using the first camera, the target biological information image comprising identifiable biological information of the target object;
performing image recognition processing based on the target biological information image, to obtain object identity information of the target object according to the identifiable biological information in the target biological information image; and
providing the target object with a target service of the plurality of services based on the object identity information.

2. The method according to claim 1, wherein:
the historical usage information comprises a quantity of transaction orders on the device in a first historical time period, a transaction amount on the device in the first historical time period and a size of a database associated with the device in the first historical time period; and
the selecting comprises:
when the quantity of transaction orders on the device, the transaction amount on the device, and the size of the database associated with the device respectively satisfy corresponding preset requirements, determining whether a worker exists onsite with the device; and
selecting a color camera as the first camera when a worker exists onsite with the device.

3. The method according to claim 2, the method further comprising:
selecting an infrared camera as the first camera when no worker exists onsite with the device.

4. The method according to claim 1, further comprising:
determining whether the device has performed a first type of scanning operations in a second historical time period, the first type of scanning operations being configured to scan electronic codes;
adjusting the device to have a first focal length for a second type of scanning operations when the device lacks the first type of scanning operations in the second historical time period, the second type of scanning operations being configured to scan for biological information; and
setting the device into a first mode to solely perform the second type of scanning operations in a preset future time period.

5. The method according to claim 4, the method further comprising:
adjusting the device to have a second focal length for the first type of scanning operations when the device has performed at least a scanning operation of the first type in the second historical time period;
determining a type of a to-be-recognized object; and
determining, based on the type of the to-be-recognized object, whether to switch the device to the first mode.

6. The method according to claim 2, wherein the determining comprises:
obtaining a site picture of a location of the device;
performing image recognition on the site picture to obtain a site recognition result; and
determining whether a worker exists onsite with the device based on the site recognition result.

7. The method according to claim 1, wherein:
the historical usage information comprises a quantity of transaction orders on the device in a first historical time period, a transaction amount on the device in the first historical time period, and a size of a database associated with the device in the first historical time period; and
the selecting comprises:
selecting a color camera and an infrared camera from the plurality of cameras when at least one of the quantity of transaction orders, the transaction amount, and/or the size of the database in the first historical time period does not satisfy a corresponding preset requirement.

8. The method according to claim 1, wherein the obtaining comprises:
taking a video clip comprising the identifiable biological information by using the first camera; and
selecting, based on a shooting angle and a picture parameter of the identifiable biological information, a picture screenshot from the video clip as the target biological information image, the picture screenshot comprising the identifiable biological information.

9. The method according to claim 1, wherein the performing the image recognition processing comprises:
matching the target biological information image with biological information in a first database of the device for biological information recognition; and
obtaining, when the matching is successful, the object identity information corresponding to the identifiable biological information from the first database of the device.

10. The method according to claim 9, the method further comprising:
transmitting the target biological information image to a server when the matching with the biological information in the first database of the device is not successful, the server matching the target biological information image with biological information in a second database of the server;
receiving, when the matching with the biological information in the second database of the server is successful, object identity information corresponding to the identifiable biological information, the object identify information being transmitted by the server; and
receiving, when the matching with the biological information in the second database of the server fails, prompt information indicating a recognition failure, the prompt information being transmitted by the server.

11. The method according to claim 10, the method further comprising:
receiving, at an interval of a preset time period, biological information transmitted by the server, to update the first database of the device.

12. An apparatus, comprising processing circuitry configured to:
select, based on historical usage information of the apparatus for biological information recognition, at least a first camera from a plurality of cameras of the apparatus, the plurality of cameras being configured to respectively collect biological information images for a plurality of services;
configure at least a second camera in the plurality of cameras in a power saving mode, the second camera not being selected based on the historical usage information of the apparatus;
obtain a target biological information image of a target object by using the first camera, the target biological information image comprising identifiable biological information of the target object;
perform image recognition processing based on the target biological information image, to obtain object identity information of the target object according to the identifiable biological information in the target biological information image; and
provide the target object with a target service of the plurality of services based on the object identity information.

13. The apparatus according to claim 12, wherein:
the historical usage information comprises a quantity of transaction orders on the apparatus in a first historical time period, a transaction amount on the apparatus in the first historical time period, and a size of a database associated with the apparatus in the first historical time period; and
the processing circuitry is configured to:
when the quantity of transaction orders on the apparatus, the transaction amount on the apparatus and the size of the database associated with the apparatus respectively satisfy corresponding preset requirements, determine whether a worker exists onsite with the apparatus; and
select a color camera as the first camera when a worker exists onsite with the apparatus.

14. The apparatus according to claim 13, wherein the processing circuitry is configured to:
select an infrared camera as the first camera when no worker exists onsite with the apparatus.

15. The apparatus according to claim 12, wherein the processing circuitry is configured to:
determine whether the apparatus has performed a first type of scanning operations in a second historical time period, the first type of scanning operations being configured to scan electronic codes;
adjust the apparatus to have a first focal length for a second type of scanning operations when the apparatus lacks the first type of scanning operations in the second historical time period, the second type of scanning operations being configured to scan for biological information; and
set the apparatus into a first mode to solely perform the second type of scanning operations in a preset future time period.

16. The apparatus according to claim 15, wherein the processing circuitry is configured to:
adjust the apparatus to have a second focal length for the first type of scanning operations when the apparatus has performed at least a scanning operation of the first type in the second historical time period;
determine a type of a to-be-recognized object; and
determine, based on the type of the to-be-recognized object, whether to switch the apparatus to the first mode.

17. The apparatus according to claim 13, wherein the processing circuitry is configured to:
obtain a site picture of a location of the apparatus;
perform image recognition on the site picture to obtain a site recognition result; and
determine whether a worker exists onsite with the apparatus based on the site recognition result.

18. The apparatus according to claim 12, wherein:
the historical usage information comprises a quantity of transaction orders on the apparatus in a first historical time period, a transaction amount on the apparatus in the first historical time period, and a size of a database associated with the apparatus in the first historical time period; and
the processing circuitry is configured to:
select a color camera and an infrared camera from the plurality of cameras when at least one of the quantity of transaction orders, the transaction amount, and/or the size of the database in the first historical time period does not satisfy a corresponding preset requirement.

19. The apparatus according to claim 12, wherein the processing circuitry is configured to:
take a video clip comprising the identifiable biological information by using the first camera; and
select, based on a shooting angle and a picture parameter of the identifiable biological information, a picture screenshot from the video clip as the target biological information image, the picture screenshot comprising the identifiable biological information.

20. A non-transitory computer-readable storage medium storing instructions which when executed by at least one processor cause the at least one processor to perform:
selecting, based on historical usage information of a device for biological information recognition, at least a first camera from a plurality of cameras of the device, the plurality of cameras being configured to respectively collect biological information images for a plurality of services;
configuring at least a second camera in the plurality of cameras in a power saving mode, the second camera not being selected based on the historical usage information of the device;
obtaining a target biological information image of a target object by using the first camera, the target biological information image comprising identifiable biological information of the target object;
performing image recognition processing based on the target biological information image, to obtain object identity information of the target object according to the identifiable biological information in the target biological information image; and
providing the target object with a target service of the plurality of services based on the object identity information.
